(19) United States
(12) Patent Application Publication
(10) Pub. No.: US 2012/0218776 A1
(43) Pub. Date: Aug. 30, 2012

(54) COMPOSITE COLOR SEPARATION SYSTEM

(75) Inventors: CHI-HUNG LEE, Hsinchu County (TW); Hui-Hsiung Lin, Hsinchu County (TW); Jen-Hui Tsai, Hsinchu City (TW)

(73) Assignee: Industrial Technology Research Institute, Hsin-chu (TW)

(21) Appl. No.: 13/404,416

(22) Filed: Feb. 24, 2012

(30) Foreign Application Priority Data
Feb. 25, 2011 (TW) 100106341

(51) Int. Cl. F21V 13/04; F21V 5/04

(52) U.S. Cl. 362/606

(57) ABSTRACT

A color separation system is disclosed, which comprises: a wavelength distribution module, a light guide module and a light splitting module. The wavelength distribution module includes at least one lighting unit and at least one lens unit, in which each lighting unit emits at least two beams of different wavelengths. The plurality of beams is directed to enter the lens unit before it is discharged out of the wavelength distribution module. After that, the plural beams from the wavelength distribution module enters the light guide module. The portion of those beams that are being absorbed, while the portion of those beams being discharged out of the light guide module and then enter the light splitting module. The light splitting module is functioned for splitting the plural beams.

### TECHNICAL FIELD

The present disclosure relates to a composite color separation system.

### TECHNICAL BACKGROUND

In a flat display, a backlight source is often used in combination with a spatial light modulator and a color filter to present full-color images. In an image sensor of a digital camera, a color filter is also used in combination with color difference calculation to reproduce the color of an original object. In larger systems such as a color video camera or a back projection TV, a three-plate or two-plate prism set or a color filter is used in combination with a collimated light source to present full-color images. When the color filter is used in such systems, because each shading pixel can only present a single primary color of the RGB three primary colors, about two-thirds of energy of the incident white light is absorbed, thus decreasing the efficiency of using the light and shortening the lifespan of the battery. In addition, fabrication of the color filter can be rather complex and more than one semiconductor photolithography processes are needed for each primary color, which results in a high cost.

Please refer to FIG. 1 to FIG. 3, which show a common light separation architecture used in conventional color camcorders. There are three types of light separation architectures, which are a three-plate prism-type optical system composed of a zoom lens 1, an infrared filter 2, a three-plate prism 3, a red light charge-coupled device (CCD) 4, a green light CCD 5, and a blue light CCD 6, as shown in FIG. 1; a two-plate dichroic prism-type optical system composed of a zoom lens 1, an infrared filter 2, a two-plate prism 7, a red-blue filter 8, a red-blue light CCD 9, a green light CCD 5, as shown in FIG. 2; and an optical system with single-plate color filter composed of a zoom lens 1, an infrared filter 2, a red-green-blue filter 10 and a red-green-blue light CCD 11, as shown in FIG. 3 Among which, both the optical systems shown in FIG. 1 and FIG. 2, that are designed to achieve light separation by the use of their prisms and optical interference films, are disadvantageous in their bulky sizes and complex structures with plenty of optical elements required. However, the optical structure shown in FIG. 3, which directly uses a color filter for light separation, can be suffered by its low optical efficiency.

### TECHNICAL SUMMARY

The present disclosure provides a composite color separation system capable of preventing unwanted light reflection from happening by the use of an absorbing zone configured therein, while simultaneously capable of acting in replacement of the conventional color filters used in optical devices, such as display panels, image sensors and color camcorders, for its simplicity and high optical efficiency.

In an embodiment, the present disclosure provides a color separation system, which comprises: at least one wavelength distribution module, each being configured with at least one lighting unit and at least one lens unit in a manner that each lighting unit is composed of an array of lighting elements while enabling at least two types of lighting elements to be included in one array for enabling each lighting unit to emit correspondingly at least two beams of different wavelengths to the at least one lens unit and then out of the at least one wavelength distribution module; a light guide module, configured with a first light incident surface, a light guide structure, a first light emergence surface, and an absorption zone, and provided for the plural beams from the at least one wavelength distribution module to enter the light guide module through the first light incident surface, and thereafter, enabling the portion of those beams being directed toward the light guide structure to be guided to the first light emergence surface where to be discharged out of the light guide module while enabling the portion of those beams that are directed toward the absorption zone to be absorbed thereby; and a light splitting module, for receiving the plural beams emitted from the light guide module while enabling the plural beams to be split thereby before being discharged out of the light splitting module.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic diagram showing a conventional three-plate prism-type optical system.

FIG. 2 is a schematic diagram showing a conventional two-plate dichroic prism-type optical system.

FIG. 3 is a schematic diagram showing a conventional optical system with single-plate color filter.

FIG. 4 to FIG. 6 are schematic diagrams showing a composite color separation system disclosed in TW Pat. Appl. No. 099110073.

FIG. 7 is a three-dimensional diagram showing a composite color separation system according to a first embodiment of the present disclosure.

FIG. 8 is a top view of a wavelength distribution module with lens units according to the first embodiment of the present disclosure that illustrates the optical paths of the incident beams traveling from the wavelength distribution module to the light guide module.

FIG. 9 is a side view of a wavelength distribution module with lens units according to the first embodiment of the present disclosure that illustrates the optical paths of the incident beams traveling from the wavelength distribution module to the light guide module.

FIG. 10 is a side view of a light splitting module according to an embodiment of the present disclosure.

FIG. 11 is a schematic diagram showing a light spitting module with single-sided periodic composite microstructure according to an embodiment of the present disclosure.

FIG. 12 is a schematic diagram showing a light spitting module with single-sided periodic composite microstructures according to another embodiment of the present disclosure.

FIG. 13 is a schematic diagram showing the light splitting module of FIG. 10 being configured with the third light emergence surface of FIG. 11.

FIG. 14 is a schematic diagram showing the light splitting module of FIG. 10 being configured with the third light emergence surface of FIG. 12.

FIG. 15 is a top view of a composite color separation system according to a second embodiment of the present disclosure.

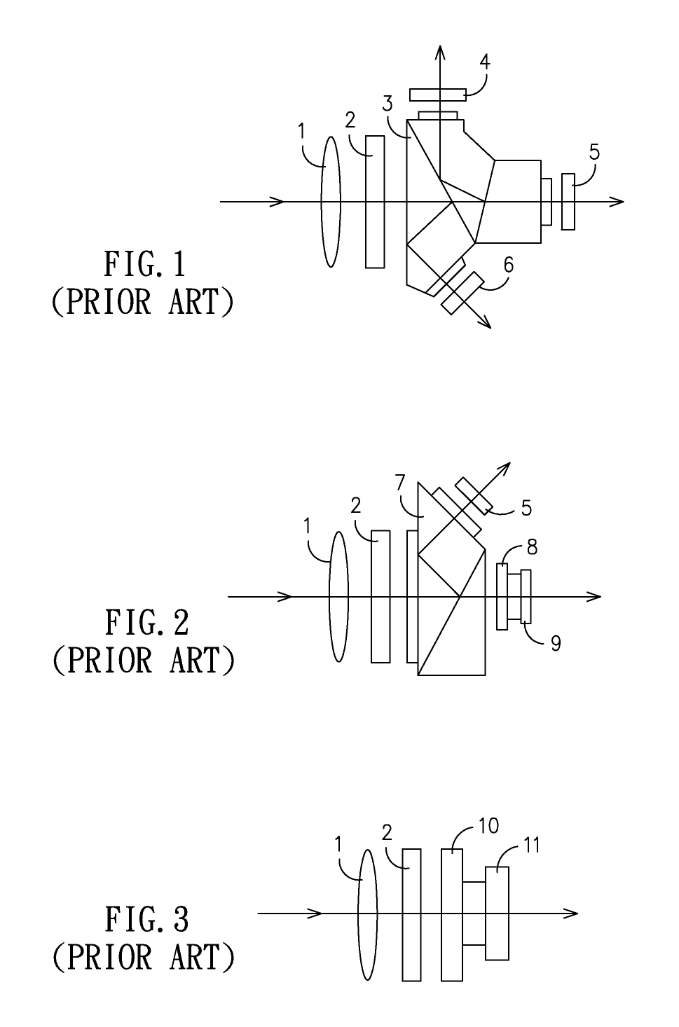

### DESCRIPTION OF THE EXEMPLARY EMBODIMENTS

For your esteemed members of reviewing committee to further understand and recognize the fulfilled functions and structural characteristics of the disclosure, several exemplary embodiments cooperating with detailed description are presented as the follows.

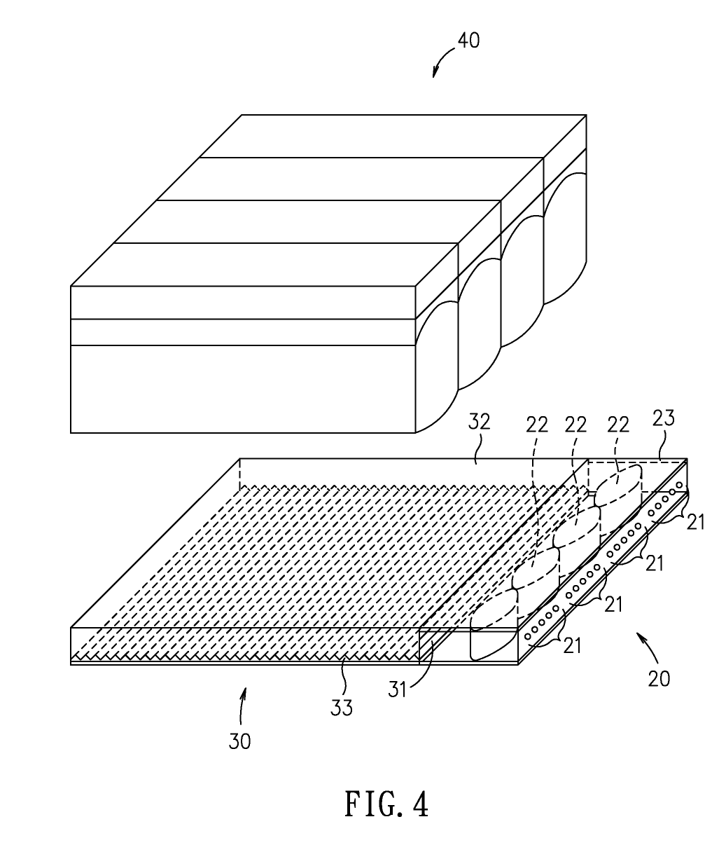

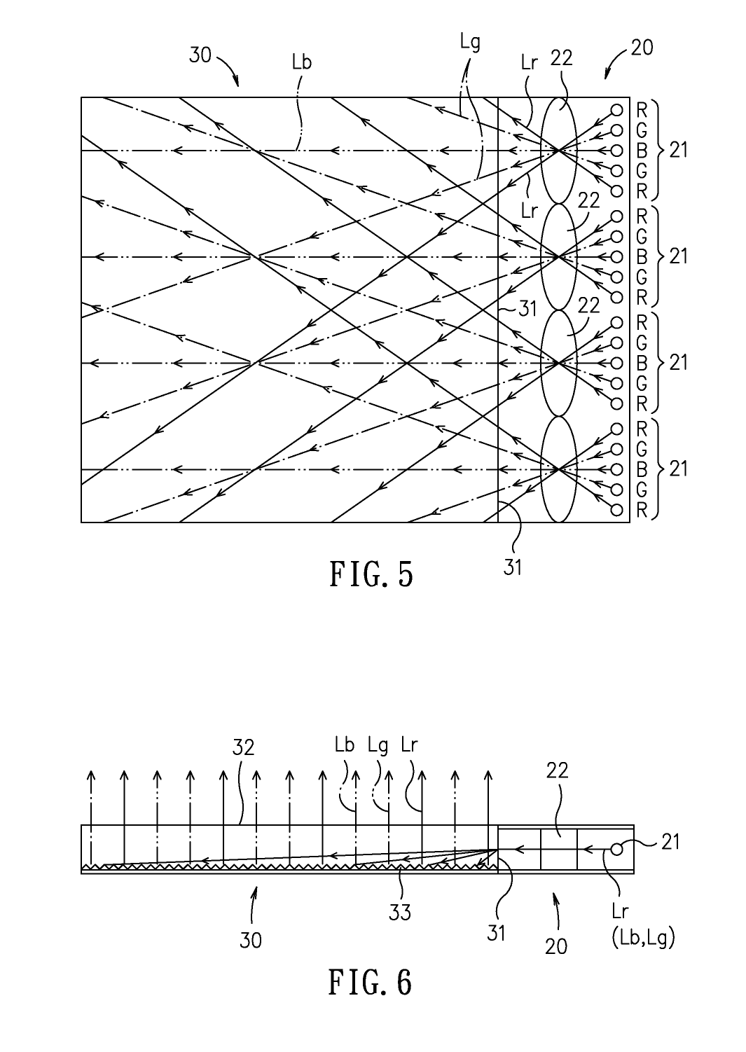

A color separation system should be able to separating an incident beam into a red, a green and a blue light beam that are directed to enter a liquid crystal layer of a display panel in a vertical manner with satisfactory optical efficiency. In response to that, a composite color separation system is provided and disclosed in TW Pat. Appl. No. 099110073. As shown in FIG. 4 to FIG. 6, In FIG. 4, the composite color separation system is comprised of: a light control module 20, a light guide module 30 and a light splitting module 40, in which the light control module 20 is used for collimating or converging a plurality of incident beams of various wavelengths to the light guide module 30 by different incident angles; the light guide module 30, being configured with a first light incident surface 31 and a first light emergence surface 32, is used for guiding the plural incident beams entering therein from the light control module 20 to the first light emergence surface 32 where they are discharged out of the light guide module 30 and then enter the light splitting module 40; and the light splitting module 40 is used for enabling the received beams to travel in a specified direction or respectively toward a specified location. Moreover, the aforesaid patent application is characterized in that: each of its lighting units 21 that is configured in the light control module 20 is composed of a plurality of symmetrically disposed lighting elements. In addition, in each lighting unit 21 shown in FIG. 5, the blue-light LED is being arranged at the center while enabling the two red-light LEDs and the two green-light LEDs to be arranged symmetrically at the two opposite sides of the blue-light LED. In detail, the two green-light LEDs are respectively and symmetrically arranged at the two opposite sides of the blue-light LED, whereas the two red-light LEDs are being respectively and symmetrically arranged at the outer sides of their corresponding green-light LEDs that are away from the blue-light LED. It is noted that the aforesaid color separation system is capable of being used in replacement of a conventional color filter that is adapted for display panels, image sensors and color camcorders, with enhanced optical efficiency and simplified system complexity. Under ideal condition, the first incident beam Lb, the second incident beams Lg and the third incident beams Lr that enter the light guide module 30 through the first light incident surface 31 will be directed to project completely upon the light guide structure 33 while allowing the first incident beam Lb, the second incident beams Lg and the third incident beams Lr to be reflected completely thereby and thus projecting toward the first light emergence surface 32 where they are projected out of the light guide module 30 toward the light splitting module 40, as shown in FIG. 6. However, since each lighting units 21 in the aforesaid composite color separation system is composed of a plurality of symmetrically disposed lighting elements, it will emit a plurality of symmetrically-arranged beams simultaneously, e.g. Lr, Lg, Lb, Lg, Lr as shown in FIG. 5. Consequently, each full-pixel in the TFT-LCD panels using the aforesaid composite color separation system will have to be designed with five sub-pixels. Therefore, the present application further improves the design of the aforesaid composite color separation system so as to provide an improved composite color separation system suitable for those currently available TFT-LCD panels having each full-pixel being composed of three sub-pixels.

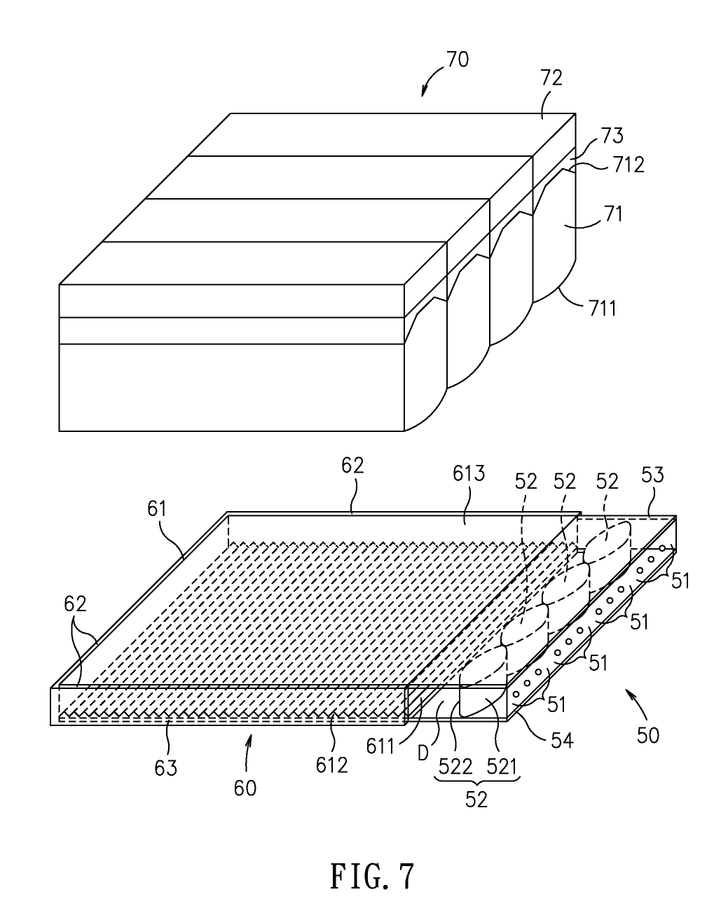

Please refer to FIG. 7, which is a three-dimensional view of a composite color separation system according to an embodiment of the present disclosure. In FIG. 7, the composite color separation system is comprised of: a wavelength distribution module 50, a light guide module 60 and a light splitting module 70, in which the wavelength distribution module 50 is used for collimating or converging a plurality of incident beams of various wavelengths to the light guide module 60 by different incident angles; the light guide module 60, being configured with a first frame 61 having a first light incident surface 611, a light guide structure 612, a first light emergence surface 613 and an absorption zone 62, is provided for the plural beams from the wavelength distribution module 50 to enter the light guide module 60 through the first light incident surface 611, and thereafter, enabling the portion of those beams being directed toward the light guide structure 612 to be guided to the first light emergence surface 613 where to be discharged out of the light guide module 60, while enabling the portion of those beams that are directed toward the absorption zone 62 to be absorbed thereby; and a light splitting module 70, used for enabling the received beams to travel in a specified direction or respectively toward a specified location.

As the embodiment shown in FIG. 7 to FIG. 9, the wavelength distribution module 50 is configured with a plurality of lighting units 51 and a plurality of corresponding lens unit 52 in a one-on-one manner, as the four lighting units 51 and four lens units 52 shown in FIG. 7, whereas each lighting unit 51 is an array of three lighting elements. Moreover, in the exemplary embodiment, the periods of the lighting units 51 and the lens units 52 are ranged between 100 μm and 1500 μm, but they can be determined according to actual requirement and thus are not limited thereby.

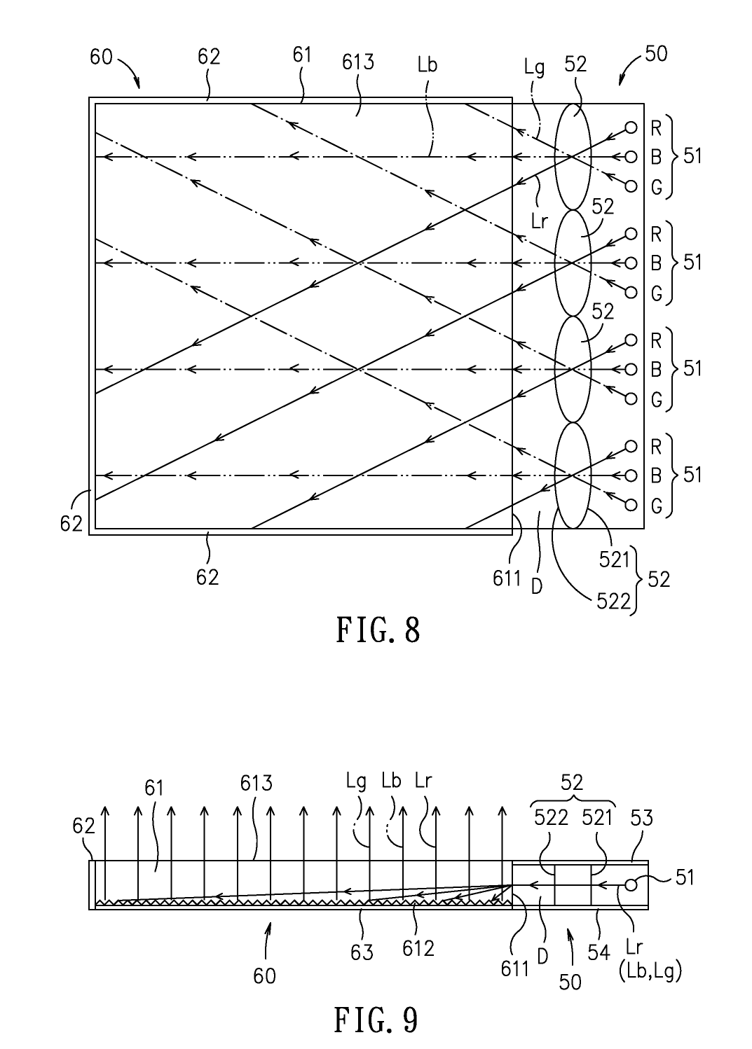

In addition, each of the lighting units 51 is composed of a plurality of lighting elements for emitting beams of different wavelengths. It is noted that the lighting unit can be any type of light source, for instance, it is a collimated light source capable of emitting a visible beams whose wavelength is ranged between 380 nm and 780 nm, such as a laser diode (LD) or a light-emitting diode (LED). In this embodiment, each of the lighting unit 51 is composed of one red-light LED, one green-light LED and one blue-light LED, representing as R, G, and B in FIG. 8. In this embodiment, the red-light LED R is used for emitting a first incident beam Lr of a first wavelength, the blue-light LED B is used for emitting a second incident beam Lb of a second wavelength, and the green-light LED G is used for emitting a third incident beam Lg of a third wavelength. In addition, in each lighting unit 51 shown in FIG. 8, the first incident beam Lr from the red-light LED R, the second incident beam Lb from the blue-light LED B and the third incident beam Lg from the green-light LED G are projected toward their corresponding lens unit 52 while allowing the incident angle of each of the incident beams with respect to the optical axis of its corresponding lens unit 52 to be ranged between −45 degrees and +45 degrees. It is noted that the range of the incident angle can be varied according to actual requirement, and thus is not limited thereby.

In this embodiment, each of the lens units 52 can be made of a transparent lens having a refraction microstructures or diffraction microstructures formed thereon, and the refractive indexes of the lens unit 52 should be ranged between 1.35 and 1.65. As the embodiment shown in FIG. 8, each of the lens units 52 is a biconvex lens configured with a second light incident surface 521 and a second light emergence surface 522. Accordingly, the first incident beams Lr, the second incident beam Lb and the third incident beams Lg that are projected to the lens unit 52 will enter the lens unit 52 through the second light incident surface 521 and then out of the same through the second light emergence surface 522 and further out of the wavelength distribution module 50. It is noted that there is a gap D formed between the second light emergence surface 522 and the first light incident surface 611 of the light guide module 60, whereas the gap D is filled with air whose refractive index is about 1.0. Thereby, the first incident beams Lr, the second incident beams Lb and the third incident beams Lg can be collimated and converged by the lens units 52 in a manner that they are respectively projected to the light guide module 60 by different incident angles.

In addition, the wavelength distribution module 50 further comprises a first reflective structure, which includes a first reflection panel 53 and a second reflection panel 54 that are disposed respectively covering a top surface and a bottom surface of the wavelength distribution module 50, as shown in FIG. 7 and FIG. 9. By the reflection of the first reflection panel 53 and the second reflection panel 54, the amount of the plural incident beams including the first incident beams Lr, the second incident beams Lb and the third incident beams Lg, that are reflected and thus projected toward and passing the lens units 52 is increased so that the light harvesting efficiency is increased. Nevertheless, the arrangement of the first reflective structure is dependent upon actual requirement, that it can be arranged at a side of the wavelength distribution module 50 and is not being limited to be configured with the aforesaid first reflection panel 23 and the second reflection panel 24 that are disposed respectively covering the top and bottom of the wavelength distribution module 50.

As shown in FIG. 7 to FIG. 9, the light guide module 60 comprises a first frame 61, being a transparent rectangle-shaped object having the first light incident surface 611 to be constructed on a side thereof that is arranged proximate to the wavelength distribution module 50, the light guide structure 612 to be constructed on the bottom thereof, the first light emergence surface 613 to be constructed on the top thereof at a position opposite to the light guide structure 612, and the absorption zone 62 to be constructed on all the other sides of the first frame 61 whichever is not being constructed with the first light incident surface 611, the light guide structure 612 and the first light emergence surface 613. It is noted that the first frame 61, being a transparent rectangle-shaped object, can be made of a transparent material such as PMMA, COP or PC, and so on; and the light guide structure 612 can be a structure of reflection/refraction microstructures or a structure of V-shaped grooves. Moreover, the absorption zone 62 can be formed on the aforementioned sides of the first frame 61 by procedures selected from the group consisting of: coating, blackening, napping, sand blasting, roughing and the like; or by attaching a component with light absorbability and anti-reflectivity on the aforementioned sides of the first frame 61. It is noted that the component can be made of a material with light absorbability ability, such as a UV-curable type or thermal-curable type resins thin film black matrix material, a high performance black photoresist mixture of DPHA (dipentaerythritol pena-/hexa-acrylate) and a photoinitiator with high light extinction coefficient, e.g. CGI-242 and 1369, or Amorphous silicon germanium (a-siGe:H). In addition, the light guide module 60 further comprises a second reflective structure, that is disposed covering a third reflection panel 63 arranged on a bottom surface of the light guide module 60, whereas the third reflection panel 63 is disposed on a surface of the light guide module 60 that is opposite to where the first light emergence surface 613 are disposed, i.e. the two are disposed respectively on the top and bottom of the light guide module 60. Consequently, by the reflection of the third reflection panel 63, the amount of the first incident beams Lr, the second incident beams Lb and the third incident beams Lg, that are reflected and thus projected toward the first light emergence surface 613 is increased so that the light harvesting efficiency is increased.

Accordingly, as soon as the first incident beams Lr, the second incident beams Lb and the third incident beams Lg are projected entering the light guide module 60 through the first light incident surface 611, the portion of those beams being directed toward the light guide structure 612 will be guided to the first light emergence surface 613 where to be discharged out of the light guide module 60 and then enter the light splitting module 70, as shown in FIG. 9. Thereafter, the first incident beam Lr, the second incident beams Lb and the third incident beams Lg that are projected entering the light splitting module 70 will be converged and enabled to travel in a specified direction or respectively toward a specified location. However, for the portion of those beams that are directed toward the absorption zone 62, it will to be absorbed thereby without be reflected. Consequently, the portion of those beams that are guided by the light guide structure 612 toward the first light emergence surface 613 will not be affected by any other beams that are resulting from light reflection or scattering inside the light guide module 60, so that the contrast and color saturation of any device using the aforesaid color separation system can be greatly enhanced in view of the efficiency defined by NTSC (National Television Standard Committee). Although there will be portions of the first incident beams Lr, the second incident beams Lb and the third incident beams Lg being absorbed by the absorption zone 62, causing certain adverse affect upon the light harvesting efficiency, the overall performance of the composite color separation system using the absorption zone 62 is far better than those without the absorption zone 62 and thus suffering by the affection of reflection and scattering. Substantially, by appropriately adjusting the cooperation between all the components used in the composite color separation system of the present disclosure in view of the light-emitting angles of the red, blue and green LEDs, the curvatures of the lens unit 22 or the refractive index of the first frame 61, etc., most of the first incident beams Lr, the second incident beams Lb and the third incident beams Lg will be enabled to project directly toward the light guide structure 612 while allowing a small portions of those beams to be prevented from being projected directly toward the light guide structure 612. Nevertheless, even the reflection resulting from a small portion of incident beams encountering the sides of the first frame 61 will have severe affection in view of the efficiency defined by NTSC. Thus, by arranging the absorption zone 62 at the sides of the first frame 61 for absorbing the portions of beams that are not projected directly toward the light guide structure 612, the performance of the color separation system of the present disclosure can be enhanced in view of the efficiency defined by NTSC.

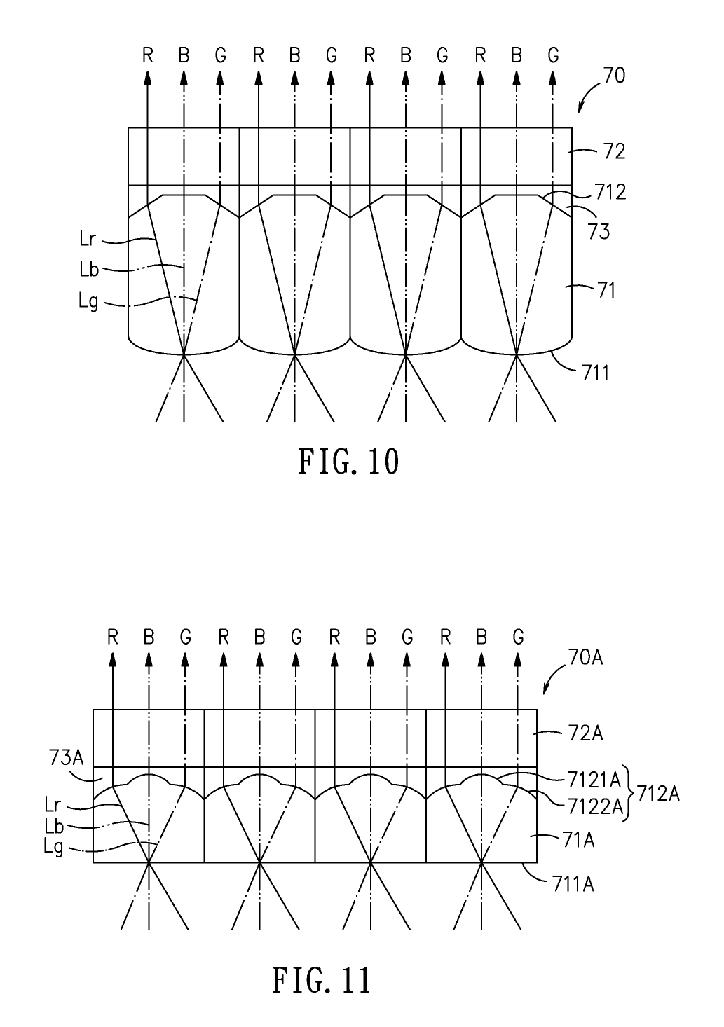

The light splitting module 70 is used for receiving beams from the light guide module 60 while splitting the same before being discharged out of the splitting module 70. Please refer to FIG. 7 and FIG. 10, which show a light splitting module 70 according to an embodiment of the present disclosure. In this embodiment, the light splitting module 70 further comprises: a first beam splitter 71 and a panel 72 that are laminated with each other by an adhesive 73. In this embodiment, the refractive index of the first beam splitting plate 71 is ranged between 1.35 and 1.65, while the refractive index of the adhesive 73 is ranged between 1.3 and 1.58. Moreover, the panel 72 can be a TFT-LCD panel. As shown in FIG. 10, the first beam splitter 71 is configured with a third light incident surface 711 and a third light emergence surface 712 while allowing the third light incident surface 711 and the third light emergence surface 712 to be formed with periodic microstructures. In this embodiment, the third light incident surface 711 is formed with periodic spherical refraction microstructures while the third light emergence surface 712 is formed with periodic refraction microstructures. Thereby, the first incident beams Lr, the second incident beams Lb and the third incident beams Lg from the first light emergence surface 613 of the light guide module 60 are projected onto the third light incident surface 711 where they are converged and then being directed to the third light emergence surface 712, at which the optical paths of the first incident beams Lr, the second incident beams Lb and the third incident beams Lg are deflected toward the panel 72 in positions respectively corresponding with different sub-pixels thereof, as the positions R, G, and B indicated in the FIG. 10, while being enabled to be discharged thereout in a direction parallel with the normal direction of the first light emergence surface 613 of the light guide module 60 and then entering sequentially into the adhesive 73, the panel 72, and thereafter out of the panel 72.

In the aforesaid light splitting module 70, both of the third light incident surface 711 and the third light emergence surface 712 of the first beam splitter 71 are formed with periodic microstructures, that is, the light splitting module 70 is a component with double-sided periodic composite microstructures. However, the light splitting module 70 can be constructed as a component with single-sided periodic composite microstructures. That is, there can only be one surface selected from the third light incident surface 711 and the third light emergence surface 712 to be formed with periodic microstructures. As shown in FIG. 11, the light splitting module 70A comprises: a first beam splitter 71A and a panel 72A that are laminated with each other by an adhesive 73A. Similarly, not only the panel 72A can be a TFT-LCD panel, but also the first beam splitter 71A is configured with a third light incident surface 711 A and a third light emergence surface 712A while allowing the third light incident surface 711A to be formed as a planar surface without any periodic microstructures and the third light emergence surface 712A to be formed with periodic composite microstructures. In this embodiment, periodic composite microstructures formed on the third light emergence surface 712A is composed of a plurality of first microstructures 7121A and a plurality of second microstructures 7122A, that are arranged for enabling each first microstructure 7121A to be sandwiched by two second microstructures 7122A that are disposed symmetrically surrounding the first microstructure 7121A so as to complete one period of microstructure array unit, whereas each of the first microstructures 7121A as well as the second microstructures 7122A is a spherical refraction microstructure.

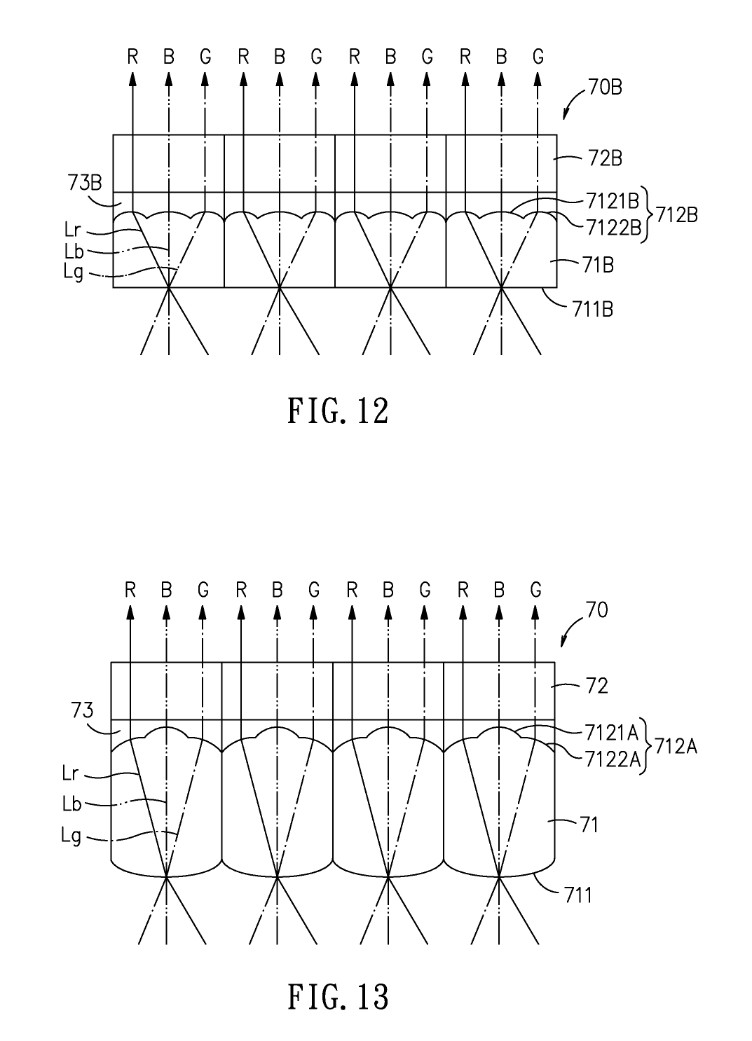

Please refer to FIG. 12, which is a schematic diagram showing a light spitting module with single-sided periodic composite microstructures according to another embodiment of the present disclosure. As shown in FIG. 12, the light splitting module 70B comprises: a first beam splitter 71B and a panel 72B that are laminated with each other by an adhesive 73B. Similarly, not only the panel 72B can be a TFT-LCD panel, but also the first beam splitter 71B is configured with a third light incident surface 711B and a third light emergence surface 712B while allowing the third light incident surface 711B to be formed as a planar surface without any periodic microstructures and the third light emergence surface 712B to be formed with periodic composite microstructures. In this embodiment, periodic composite microstructures formed on the third light emergence surface 712B is composed of a plurality of first microstructures 7121B and a plurality of second microstructures 7122B, that are arranged for enabling each first microstructure 7121A to be sandwiched by two second microstructures 7122A that are disposed symmetrically surrounding the first microstructure 7121A so as to complete one period of microstructure array unit, whereas each of the first microstructures as well as the second microstructures is a spherical refraction microstructure. Nevertheless, the difference between the embodiment shown in FIG. 12 and that shown in FIG. 11 is that: the curvatures of the first microstructures 7121B and the second microstructures 7122B are different from those of the two microstructures of FIG. 11. Thus, it is noted that the curvatures of the first microstructures and the second microstructures can be varied according to actual requirement and thus will not be limited by the aforesaid embodiments.

In the single-sided periodic composite microstructures shown in FIG. 11 and FIG. 12, one full period defined by the periodic microstructures will include at least one secondary period, i.e. the first microstructure 7121A and the second microstructure 7122A, or the first microstructure 7121B and the second microstructure 7122B, and the secondary period is a period selected from the group consisting of: a constant period and a variational period. In addition, the microstructures included in the range of each secondary period are microstructures selected from the group consisting of: microstructures for deflecting incident beams and microstructure with asymmetrical curves.

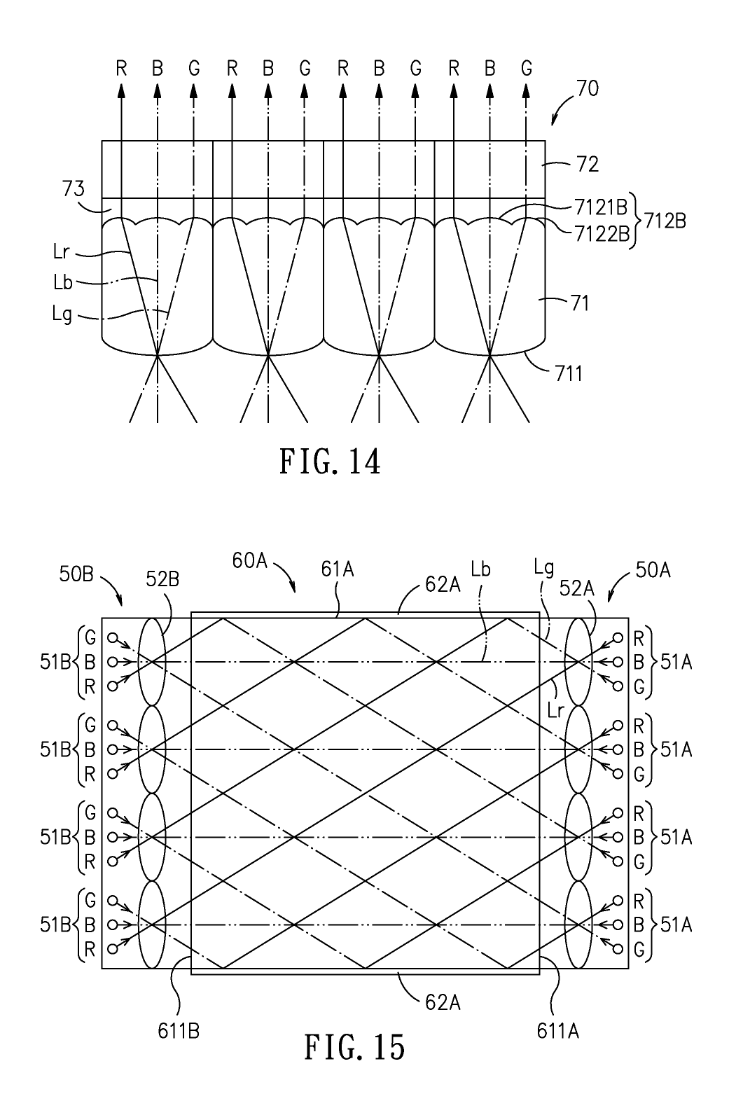

It is obvious that the third light emergence surfaces 712A and 712B shown in FIG. 11 and FIG. 12 can both be applied in the light splitting module 70 of FIG. 10 for acting in replacement of the third light emergence surface 712, as the embodiments shown in FIG. 13 and FIG. 14. That is, the period of the double-sided periodic composite microstructures shown in FIG. 10 can be a constant period or a variational period.

Please refer to FIG. 15, which is a top view of a composite color separation system according to a second embodiment of the present disclosure. In this embodiment, the composite color separation system has two wavelength distribution modules, which are a first wavelength distribution module 50A and a second wavelength distribution module 50B. The first wavelength distribution module 50A has at least one first lighting unit 51A and at least one first lens unit 52A, in which each first lighting unit 51A is composed of a red-light LED, a blue-light LED and a green-light LED, representing as R, B, and G in FIG. 15, whereas the red-light LED is used for emitting a first incident beam Lr of a first wavelength, the blue-light LED is used for emitting a second incident beam Lb of a second wavelength, and the green-light LED is used for emitting a third incident beam Lg of a third wavelength. Similarly, the second wavelength distribution module 50B also has at least one second lighting unit 51B and at least one second lens unit 52B, in which each second lighting unit 51B is composed of a red-light LED, a blue-light LED and a green-light LED, representing as R, B, and G in FIG. 15, whereas the red-light LED is used for emitting a first incident beam Lr of a first wavelength, the blue-light LED is used for emitting a second incident beam Lb of a second wavelength, and the green-light LED is used for emitting a third incident beam Lg of a third wavelength. Accordingly, it is noted that the amount of lighting first lighting unit 51A being included in the first wavelength distribution module 50A is the same that of the second lighting unit 51B in the second wavelength distribution module 50B, i.e. there are four lighting units in each of the two wavelength distribution modules, and as each first lighting unit 51A is composed of one red-light LED, one blue-light LED and one green-light LED, and also each second lighting unit 51B is composed of one red-light LED, one blue-light LED and one green-light LED, the amount of lighting elements included in one first lighting unit 51A as well as the wavelengths being emitted therefrom are the same as the those of the second lighting unit 51B. However, the plural lighting element in each second lighting unit 51B is arranged as an array in a direction opposite to the array of lighting elements in each first lighting unit 51A. Moreover, the light guide module 60A of FIG. 15 is configured with a first frame 61A having two first light incident surfaces 611A and 611B, being arranged respectively at two opposite sides of the first frame 61A. Accordingly, the first incident beams Lr, the second incident beams Lb and the third incident beams Lg that are emitted from each first lighting unit 51A of the first wavelength distribution module 50A will enter the light guide module 60A through the first light incident surface 611A, while the first incident beams Lr, the second incident beams Lb and the third incident beams Lg that are emitted from each second lighting unit 51B of the second wavelength distribution module 50B will enter the light guide module 60A through another first light incident surface 611B. As illustrated in this embodiment, by arranging the first lighting unit 51A in reverse symmetry to the second lighting unit 51B, the intensities of the first incident beams Lr, the second incident beams Lb and the third incident beams Lg are all being increased.

To sum up, the composite color separation system of the present disclosure, being composed of wavelength distribution modules, light guide modules and light splitting modules, is capable of preventing unwanted light reflection from happening by the use of an absorbing zone configured therein, while simultaneously capable of acting in replacement of the conventional color filters used in optical devices, such as display panels, image sensors and color camcorders, for its simplicity and high optical efficiency.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A color separation system, comprising:
at least one wavelength distribution module, each being configured with at least one lighting unit and at least one lens unit in a manner that each lighting unit is composed of an array of lighting elements while enabling at least two types of lighting elements to be included in one array for enabling each lighting unit to emit correspondingly at least two beams of different wavelengths to the at least one lens unit and then out of the at least one wavelength distribution module;
a light guide module, configured with a first light incident surface, a light guide structure, a first light emergence surface, and an absorption zone, that is provided for the plural beams from the at least one wavelength distribution module to enter the light guide module through the first light incident surface, and thereafter, enabling the portion of those beams being directed toward the light guide structure to be guided to the first light emergence surface where to be discharged out of the light guide module while enabling the portion of those beams that are directed toward the absorption zone to be absorbed thereby; and
a light splitting module, for receiving the plural beams emitted from the light guide module while enabling the plural beams to be split thereby before being discharged out of the light splitting module.

2. The color separation system of claim 1, wherein the light guide module further comprises:
a first frame, being a transparent rectangle-shaped object having the first light incident surface to be constructed on a side thereof that is disposed proximate to the at least one wavelength distribution module, the light guide structure to be constructed on the bottom thereof, the first light emergence surface to be constructed on the top thereof, and the absorption zone to be constructed on at least one side of the rectangle-shaped object whichever is not being constructed with the first light incident surface, the light guide structure and the first light emergence surface.

3. The color separation system of claim 2, wherein the absorption zone is substantially a component with light absorbability and anti-reflectivity.

4. The color separation system of claim 1, the at least one wavelength distribution module includes a first wavelength distribution module and a second wavelength distribution module, while the first wavelength distribution module is configured with at least one first lighting unit and at least one first lens unit in a manner that each first lighting unit is composed of an array of lighting elements while enabling at least two types of lighting elements to be included in one array for enabling each first lighting unit to emit correspondingly at least two beams of different wavelengths to the at least one lens unit and then out of the at least one wavelength distribution module, and the second wavelength distribution module is configured with at least one second lighting unit and at least one second lens unit in a manner that each second lighting unit is composed of an array of lighting elements that are opposite to the array of lighting elements in each first lighting unit while enabling at least two types of lighting elements to be included in one array for enabling each second lighting unit to emit correspondingly at least two beams of different wavelengths; and the light guide module is configured with two of the first light incident surface that are disposed respectively at the two opposite sides of the light guide module so as to enable the plural beams from the first lighting units of the first wavelength distribution module to enter the light guide module from one of the two first light incident surface while allowing the plural beams from the second lighting units of the second wavelength distribution module to enter the light guide module from another first light incident surface.

5. The color separation system of claim 4, wherein the amount of lighting elements included in one first lighting unit as well as the wavelengths being emitted therefrom are the same as the those of the second lighting unit.

6. The color separation system of claim 1, wherein each lens unit is configured with a second light incident surface and a second light emergence surface, that are provided for the plural beams to enter the referring lens unit through the second light incident surface, and then to be discharged out of the same through the second light emergence surface toward the wavelength distribution module, while allowing the second light emergence surface to be separated from the first light incident surface of the light guide module by a gap filled with air.

7. The color separation system of claim 1, wherein the light splitting module further comprises: a first beam splitter and a panel that are laminated with each other by an adhesive; and the first beam splitter is configured with a third light incident surface and a third light emergence surface while allowing at least one surface selected from the group consisting of the third light incident surface and the third light emergence surface to be formed with periodic microstructures; and thereby, the plural beams that are projected onto the third light incident surface are directed to the third light emergence surface where the optical paths of the plural beam are deflected toward panel in positions respectively corresponding with different sub-pixels thereof, while being enabled to be discharged thereout in a direction parallel with the normal direction of the first light emergence surface of the light guide module and then entering sequentially into the adhesive, the panel, and thereafter out of panel.

8. The color separation system of claim 7, wherein one full period defined by the periodic microstructures includes at least one secondary period, and the at least one secondary period is a period selected from the group consisting of: a constant period and a variational period.

9. The color separation system of claim 8, wherein the microstructures included in the range of each secondary period are microstructures selected from the group consisting of: microstructures for deflecting incident beams and microstructure with asymmetrical curves.

10. The color separation system of claim 1, wherein each wavelength distribution module further comprises:
a first reflective structure, having a first reflection panel and a second reflection panel arranged respectively covering a top surface and a bottom surface of the wavelength distribution module.

11. The color separation system of claim 1, wherein the light guide module further comprises:
a second reflective structure, disposed covering a third reflection panel arranged on a bottom surface of the light guide module.
